(19) United States
(12) Patent Application Publication
(10) Pub. No.: US 2026/0258992 A1
(43) Pub. Date: Sep. 3, 2026

(54) COOLING SYSTEM AND AIRPLANE WITH COOLING SYSTEM

(71) Applicant: Airbus Operations GmbH, HAMBURG (DE)

(72) Inventors: Torsten TRÜMPER, HAMBURG (DE); Moritz RAPPOLD, HAMBURG (DE)

(21) Appl. No.: 19/550,475

(22) Filed: Feb. 26, 2026

(30) Foreign Application Priority Data
Feb. 28, 2025 (DE) 102025000750.7

(51) Int. Cl. F25B 49/02; B64D 13/08

(52) U.S. Cl. CPC F25B 49/02; B64D 13/08; F25B 2500/07; F25B 2500/222

(57) ABSTRACT

A cooling system comprising: a closed main refrigerant circuit which, in the direction of the circuit, includes a compressor, a condenser, an expansion valve, and an evaporator; and a safety arrangement which completely surrounds the main refrigerant circuit and an auxiliary refrigerant and/or neutralizing agent interspersed, such that in the event of a leak in the main refrigerant circuit, any main refrigerant circulating in the main refrigerant circuit must pass through the auxiliary refrigerant and/or neutralizing agent before it reaches an environment outside the safety arrangement. Also, an aircraft with such a cooling system.

### CROSS-REFERENCES TO RELATED APPLICATIONS

This application claims the benefit of German Patent Application Number 10 2025 000 750.7 filed on Feb. 28, 2025, the entire disclosure of which is incorporated herein by way of reference.

### FIELD OF THE INVENTION

The invention relates to a cooling system and an aircraft with a cooling system.

### BACKGROUND OF THE INVENTION

A cooling system typically features a closed refrigerant circuit, comprising a compressor, a condenser, an expansion valve, and an evaporator in the direction of circulation. A non-flammable refrigerant is circulated within this circuit. Such cooling systems are installed in aircraft and are considered safe due to the non-flammable refrigerant, particularly in the event of a refrigerant circuit leak.

A challenge arising from the conventional systems is the ability to use of a flammable refrigerant instead of the non-flammable refrigerant in the refrigerant circuit, while ensuring greater safety, particularly in the aforementioned case of a leak, while maintaining at least approximate efficiency.

### SUMMARY OF THE INVENTION

This issue may be solved by a cooling system and an aircraft with the cooling system according to one or more embodiments of the present invention.

The present invention may be characterized as providing a cooling system comprising: a closed main refrigerant circuit comprising, in the direction of circulation, a compressor, a condenser, an expansion valve and an evaporator; and a safety arrangement that completely surrounds the main refrigerant circuit and includes an auxiliary refrigerant and/or neutralizing agent in between, such that in the event of a leak in the main refrigerant circuit, any main refrigerant circulating in the main refrigerant circuit must pass through the auxiliary refrigerant and/or neutralizing agent before escaping into an environment outside the safety arrangement.

This design allows the efficiency of the heat-exchanging sections, i.e., the condenser and the evaporator, of the main refrigerant circuit to be maintained approximately, while in the event of a leak of the main refrigerant from the main refrigerant circuit, an additional barrier to the outside environment is present.

The main refrigerant may be a flammable or highly flammable refrigerant, for example propane.

The main refrigerant can be a refrigerant from safety class A2L or A3 of standards ISO 817 and ANSI/ASHRAE 34.

The secondary refrigerant may be a non-flammable refrigerant, for example water.

The secondary refrigerant can be a refrigerant from safety class A1 of the standards ISO 817 and ANSI/ASHRAE 34.

The neutralizing agent may be an adsorbent, for example activated carbon.

The adsorbent is a substance, preferably a solid, which, through a suitable surface, enables the adhesion of foreign substances, preferably hydrocarbons, by means of molecular bonding forces. In the case of a flammable or highly flammable main refrigerant, the adsorbent should be designed to reduce the flammability of the main refrigerant.

The safety arrangement may be divided into a compressor/expansion valve section, a condenser section and an evaporator section, each of which is spatially enclosed and spatially separated from each other and from the environment.

All of these sections may be non-circulating. In the direction of the cycle, the condenser section preferably begins after the compressor and ends before the expansion valve. In the direction of the cycle, the evaporator section preferably begins after the expansion valve and ends before the compressor. The condenser section and the evaporator section are preferably separated from each other by the compressor/expansion valve section, with which they preferably share at least one connecting wall. In this case, one side of the connecting wall would be an inner wall of the compressor/expansion valve section, and the opposite side of the connecting wall would be an inner wall of either the condenser section or the evaporator section. Furthermore, in the safety arrangement, preferably only the condenser section and the evaporator section comprise fins. These fins can project from an outer wall of the respective section outwards into the environment and/or inwards into the secondary refrigerant. In the latter case, the fins protrude into the relevant section but remain at a distance from the inner wall, which limits the main refrigerant circuit.

Furthermore, the pressure in the compressor/expansion valve section can be equal to ambient pressure or 1 bar. The pressure in the condenser section and/or evaporator section can be higher than ambient pressure or 1 bar and can reach up to 20 bar. Preferably, the pressure in the condenser section and/or evaporator section is lower than the pressure in the main refrigerant circuit.

The compressor/expansion valve section may be divided into a compressor section and an expansion valve section, each spatially closed and spatially separated from each other and from the environment.

This means that the compressor section and the expansion valve section do not have a common connecting wall as described above.

The compressor/expansion valve section may be filled with the neutralizing agent; and the condenser section and/or the evaporator section is filled with the auxiliary refrigerant.

The secondary refrigerant used in the condenser section can differ from the secondary refrigerant used in the evaporator section. Both secondary refrigerants can be selected from the aforementioned safety class A1 according to standards ISO 817 and ANSI/ASHRAE 34.

The cooling system may include one or more pressure relief devices provided in the compressor/expansion valve section to provide at least one of the following functions:
i) Absorption of excess pressure from the condenser section into the compressor/expansion valve section;
ii) ii) Absorption of overpressure from the evaporator section into the compressor/expansion valve section; and
iii) iii) Release of excess pressure from the compressor/expansion valve section into the environment.
The pressure release device is preferably a “one-time valve.” A “one-time valve” is a valve that can withstand a predetermined pressure exactly once, opens non-destructively or self-destructively after this predetermined pressure is exceeded, and then becomes a pressure-independent passage. Preferably, the “one-time valve” is arranged and designed such that it is visible from outside the safety device whether it has already opened. Such a “one-time valve” represents a rupture disc, which can be used here as a pressure release device.

The compressor/expansion valve section, the condenser section and/or the evaporator section may include pressure gauges which are used to detect a pressure change in the section concerned in the event of a leak in the main refrigerant circuit.

In some aspects, the present invention may provide an aircraft having a cooling system according to any embodiments, aspect, or example described herein.

### BRIEF DESCRIPTION OF THE DRAWINGS

The foregoing and the following detailed description will be better understood when read in conjunction with the accompanying drawings. Preferred embodiments are shown in the drawings for illustrative purposes.

FIG. 1 shows the structure of a cooling system described here as an example.

FIG. 2 shows a cross-sectional view through a section of the cooling system of FIG. 1.

FIG. 3 shows an aircraft with an aircraft cabin which, for example, has a cooling system as shown in FIG. 1 and/or one described here by way of example.

### DETAILED DESCRIPTION OF THE PREFERRED EMBODIMENTS

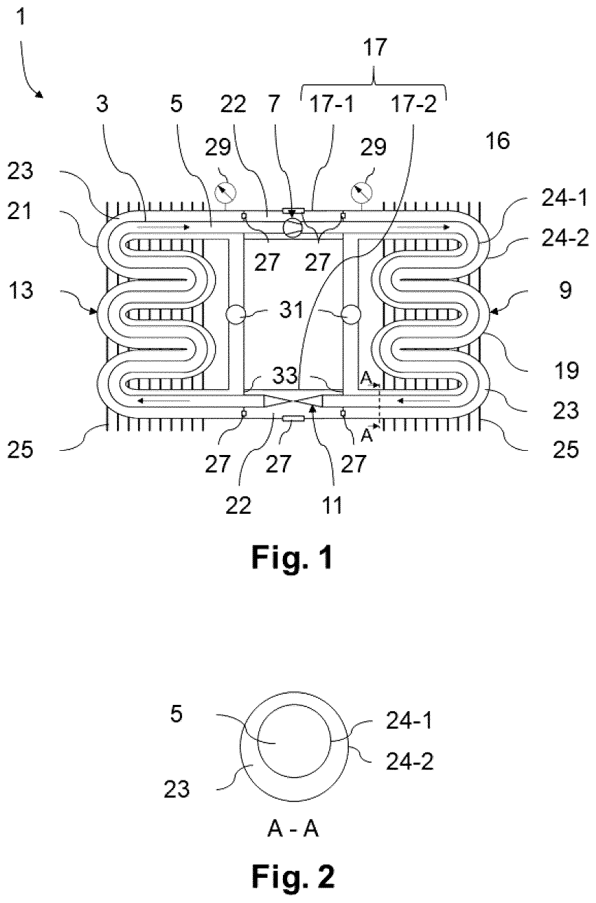

FIG. 1 shows the structure of a cooling system 1 described here as an example.

The cooling system 1 has a closed main refrigerant circuit 3 in which a main refrigerant 5, circulating in the direction of the arrow shown (circulation direction), first flows through a compressor 7, then a condenser 9, subsequently an expansion valve 11, and finally an evaporator 13, before returning to the compressor 7. The expansion valve 11 also includes a capillary tube.

The main refrigerant circuit 3 is arranged within a safety arrangement 15 in such a way that in the event of a leak, the main refrigerant 5 can escape exclusively into the safety arrangement 15, which thereby serves as a barrier for the main refrigerant 5 to the environment 16 outside the safety arrangement 15.

For the aforementioned purpose, the safety arrangement 15 is subdivided (preferably exclusively) into a compressor/expansion valve section 17, a condenser section 19, and an evaporator section 21. The compressor/expansion valve section 17 may (preferably exclusively) be subdivided into a compressor section 17-1 and an expansion valve section 17-2. These sections are each spatially closed and spatially separated from each other and from the environment 16, and—at least in a leak-free basic state of the cooling system 1, the main refrigerant circuit 3, and/or the safety arrangement 15—are designed to prevent any direct exchange of fluid contained in these sections between themselves and/or with the environment 16.

The compressor/expansion valve section 17, as well as the compressor section 17-1 and/or the expansion valve section 17-2, are partially or completely filled with a neutralizing agent 22 capable of neutralizing any main refrigerant 5 escaping from the main refrigerant circuit 3 into one of these sections 17, 17-1, or 17-2. “Neutralizing” means that a negative property of the main refrigerant 5 is reduced to such an extent that no damage can occur from the escape or the potential damage is reduced. For example, a highly flammable main refrigerant 5 can be rendered flammable, low flammability, or non-flammable by a neutralizing agent 22, such as activated carbon, located in the relevant section 17, 17-1, or 17-2.

The condenser section 19 and the evaporator section 21 are filled with a secondary refrigerant 23, which serves as a thermal bridge between an inner wall 24-1 to the main refrigerant circuit 3 and an outer wall 24-2 to the environment 16 located outside the safety arrangement 15 and the respective section 19, 21.

Fins 25 can be present on both sections 19 and 21 to increase the surface area of the outer wall 24-2 facing the environment 16 and thus promote heat exchange. Sections 19 and 21 can be designed such that the thermal conductivity between the main refrigerant 5 and the secondary refrigerant 23 is in the range of 1,000 to 10,000 W/mK. It should also be noted that the thermal resistance due to the secondary refrigerant 23, which is associated with the safety device 15, is only slightly increased compared to a cooling system 1 without the safety device 15. The additional thermal resistance is significantly lower than the thermal resistance that typically exists between the fins 25 and the ambient air 16 and which must also be overcome in a cooling system 1 without the safety device 15. While the fins 25 shown in FIG. 1 project outwards from an outer wall of the relevant section 19, 21 into the surroundings 16, fins not shown in FIG. 1 can project inwards into the secondary coolant 23 of the relevant section 19, 21. In the latter case, the fins project into the relevant section 19, 21 but remain at a distance from the inner wall 24-1, which delimits the main refrigerant circuit 3.

The pressure in the main refrigerant circuit 3 can be greater than the pressure in the compressor/expansion valve section 17—at least in a leak-free initial state of the cooling system 1, the main refrigerant circuit 3, and/or the safety arrangement 15. This also applies to compressor section 17-1 and/or expansion valve section 17-2. The pressure in the condenser section 19 and the pressure in the evaporator section 21 can lie between the pressure in the main refrigerant circuit 3 and the pressure in the compressor/expansion valve section 17, compressor section 17-1, and/or expansion valve section 17-2. These pressures can range from 1 to 20 bar.

Pressure relief devices 27, for example rupture discs, may be provided in the compressor/expansion valve section 17, as well as in the compressor section 17-1 and/or the expansion valve section 17-2, to absorb excess pressure from the condenser section 19 and/or the evaporator section 21 into the compressor/expansion valve section 17, the compressor section 17-1 and/or the expansion valve section 17-2, and/or to release excess pressure from the compressor/expansion valve section 17, the compressor section 17-1 and/or the expansion valve section 17-2 into the environment 16.

Pressure gauges 29 can be provided for pressure monitoring of the condenser section 19 and/or the evaporator section 21. Likewise, such a pressure gauge can be provided for the compressor/expansion valve section 17, the compressor section 17-1, and/or the expansion valve section 17-2, which is not shown in FIG. 1 for clarity. One pressure gauge is sufficient for each section 17, 17-1, 17-2, 19, 21.

Pumps 31 can be provided for the circulation of the auxiliary refrigerant 23 in the condenser section 19 and/or in the evaporator section 21. One pump 31 per section 19, 21 is sufficient. Alternatively, the condenser section 19 and/or the evaporator section 21 can be circulation-free sections, designed such that neither active nor passive circulation of the auxiliary refrigerant 23 is possible in the respective section 19, 21.

The main refrigerant 5 and the secondary refrigerant 23 can be classified according to the safety classes of the ISO 817 and ANSI/ASHRAE 34 standards. Refrigerants can be divided into the following classes based on their flammability and ignitability:
A1=Non-flammable
A2=Highly flammable
A2L=Flammable
A3=Highly flammable

The main refrigerant 5 can be a class A3 refrigerant, e.g. propane.

The neutralizing agent 22 can be an adsorbent, e.g. activated carbon.

The secondary refrigerant 23 can be a refrigerant of class A1, e.g. water.

FIG. 2 shows a cross-sectional view AA through a section of the cooling system 1 of FIG. 1.

The section shown in FIG. 2 is the condenser section 19. It is shown here, representative of the entire cooling system 1, that the main refrigerant circuit 3 in its cross-section is completely surrounded and spaced on its circumference by the outer wall 24-2 of the safety arrangement 15 in the direction of flow of the main refrigerant 5. This ensures that heat transfer between the inner wall 24-1 to the main refrigerant circuit 3 and the outer wall 24-2 to the environment 16 outside the safety arrangement 15 always occurs via the intermediate secondary refrigerant 23. This ensures that a leak in the main refrigerant circuit 3 always first enters one of the sections 17, 17-1, 17-2, 19, 21 of the safety arrangement 15 before the main refrigerant 5 can reach the external environment 16, as would be the case if the inner wall 24-1 and the outer wall 24-2 were in direct contact at one point. Only at the transitions of directly adjacent sections 17, 17-1, 17-2, 19, 21 are the walls of the safety assembly 15 and the main refrigerant circuit 3 still spaced apart, but connected directly to each other via a connecting wall 33, i.e., without the secondary refrigerant 23 that would otherwise be interposed. In FIG. 1, only the two connecting walls 33 of the expansion valve section 17-2 are marked with a reference numeral. The corresponding connecting walls in the compressor section 17-1 can also be identified without reference numerals. Finally, as shown in FIG. 1, a pressure relief device 27 is shown in each connecting wall.

In the most likely scenarios of a leak that would necessitate a repair or replacement of cooling system 1, the cooling system 1 described here can provide greater safety as follows:

### Leakage Variant 1

A leak from the main refrigerant circuit 3 into the compressor/expansion valve section 17, the compressor section 17-1, and/or the expansion valve section 17-2 causes the main refrigerant 5 to flow into the relevant section 17, 17-1, 17-2 along with the neutralizing agent 22, thus impairing the cooling capacity of the cooling system 1. If the pressure in the relevant section 17, 17-1, 17-2 is too high, it is designed to allow a leak to the environment 16, for example, by ensuring that the wall of the relevant section 17, 17-1, 17-2 facing the environment 16 withstands a lower pressure than the wall facing the adjacent condenser section 19 and/or the adjacent evaporator section 21, and/or by including, for example, the previously described pressure relief device 27 in the wall facing the environment 16.

### Leakage Variant 2

A leak in the main refrigerant circuit 3 into the condenser section 19 and/or the evaporator section 21 causes the main refrigerant 5 to escape into the condenser section 19 and/or the evaporator section 21, thus impairing the cooling capacity of the cooling system 1. Furthermore, the pressure gauge 29 of the relevant section 19, 21 would measure a pressure change indicating a leak.

### Leakage Variant 3

A leak from the condenser section 19 and/or the evaporator section 21 into the environment 16 causes the auxiliary refrigerant 23 to escape into the environment 16, thus impairing the cooling capacity of the cooling system 1. Furthermore, the pressure gauge 29 of the relevant section 19, 21 would measure a pressure change indicating a leak.

Each of these leakage scenarios can be detected in time and addressed accordingly. Furthermore, the safety arrangement 15 described above, which completely surrounds the main refrigerant circuit 3 and the secondary refrigerant 23 or adsorbent 22 in between, ensures that in the event of a leak in the main refrigerant circuit 3, the main refrigerant 5 circulating in the main refrigerant circuit 3 must pass through the secondary refrigerant 23 or adsorbent 22 before it reaches the environment 16 outside the safety arrangement 15.

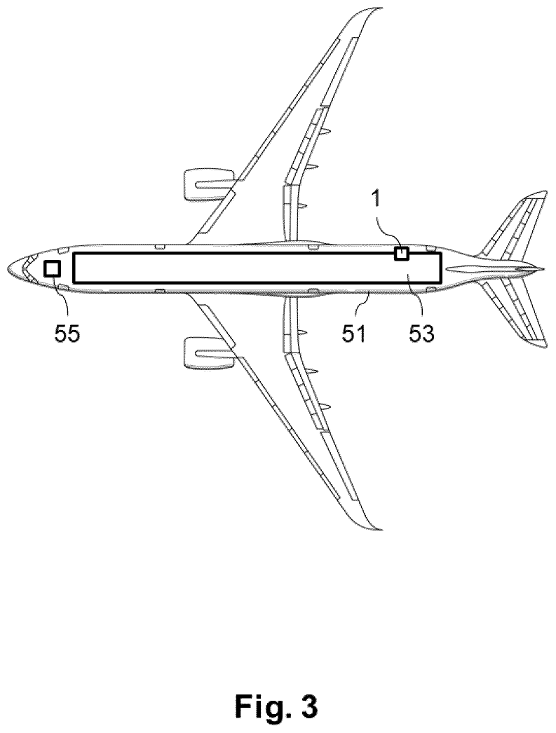

FIG. 3 shows an aircraft 51 with an aircraft cabin 53, which, for example, has a cooling system 1 as shown in FIG. 1 and/or one described here by way of example. A control system 55, arranged here by way of example in the aircraft 51, is configured to receive and process data relating to the cooling system 1 wirelessly or via cable in order to detect an abnormality in the operation of the cooling system 1. The data can be such data that allows statements about the cooling performance of the cooling system 1, for example, data on the power consumption of the cooling system 1 and data on temperature profiles of the aircraft cabin 53 to be cooled. Alternatively or additionally, the data can be data from the aforementioned pressure gauges 29.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A cooling system, comprising:
a closed main refrigerant circuit comprising, in a direction of the closed main refrigerant circuit, a compressor, a condenser, an expansion valve, and an evaporator; and
a safety arrangement that completely surrounds the closed main refrigerant circuit and an auxiliary refrigerant, or a neutralizing agent, or both between the closed main refrigerant circuit and the safety arrangement such that in an event of a leak in the closed main refrigerant circuit, a main refrigerant circulating in the closed main refrigerant circuit must pass through the auxiliary refrigerant, the neutralizing agent, or both before the main refrigerant enters an environment outside the safety arrangement.

2. The cooling system according to claim 1, wherein the main refrigerant is a flammable or highly flammable refrigerant.

3. The cooling system according to claim 1, wherein the auxiliary refrigerant is a non-flammable refrigerant.

4. The cooling system according to claim 1, wherein the neutralizing agent is an adsorbent.

5. The cooling system according to claim 1, wherein the safety arrangement is divided into a compressor/expansion valve section, a condenser section, and an evaporator section, each of which is spatially enclosed and spatially separated from each other and from the environment.

6. The cooling system according to claim 5, wherein the compressor/expansion valve section is divided into a compressor section and an expansion valve section, each of which is spatially closed and spatially separated from each other and from the environment.

7. The cooling system according to claim 5, wherein the compressor/expansion valve section is filled with the neutralizing agent,
wherein the condenser section and/or the evaporator section is filled with the auxiliary refrigerant.

8. The cooling system according to claim 5, wherein, in the compressor/expansion valve section, one or more pressure relief devices are provided to:
i) absorb excess pressure from the condenser section into the compressor/expansion valve section;
ii) absorb of overpressure from the evaporator section into the compressor/expansion valve section;
iii) release excess pressure from the compressor/expansion valve section into the environment; or
any combination of i) to iii).

9. The cooling system according to claim 5, wherein the compressor/expansion valve section, or the condenser section, or the evaporator section, or any combination thereof include a pressure gauge to detect a pressure change in a respective section in the event of the leak in the main refrigerant circuit.

10. An aircraft comprising:
the cooling system according to claim 1.
